(19) United States
(12) Patent Application Publication
(10) Pub. No.: US 2015/0242693 A1
(43) Pub. Date: Aug. 27, 2015

(54) VIDEO SURVEILLANCE DEVICE AND METHOD

(71) Applicant: HON HAI PRECISION INDUSTRY CO., LTD., New Taipei (TW)

(72) Inventor: CHUI-WEN CHIU, New Taipei (TW)

(21) Appl. No.: 14/473,651

(22) Filed: Aug. 29, 2014

(30) Foreign Application Priority Data
Feb. 24, 2014 (TW) 103106091

(51) Int. Cl. G06K 9/00; H04N 7/18; G06T 3/40

(52) U.S. Cl. CPC G06K 9/00771; G06T 3/40; H04N 7/181

(57) ABSTRACT

A video surveillance method is applied in a video surveillance device which can communicate with a number of image source devices and a number of terminal devices. The method includes receiving a request for images from at least one terminal device. If the request includes information requesting images from more than one image source device, obtaining images captured by each specified image source device in real-time, and grouping the obtained images together and transmitting same.

### FIELD

The present disclosure relates to video surveillance devices, and particularly to a video surveillance device and a video surveillance method applied by the video surveillance device.

### BACKGROUND

Surveillance systems sometimes includes more than one image source device such as a video recorder or an IP camera. Each image source device captures videos or images, and can transmit the captured videos or images over a network to at least one terminal device (for example, a mobile device or a computer), to show the videos or images on the terminal device.

### BRIEF DESCRIPTION OF THE DRAWINGS

Implementations of the present technology will now be described, by way of example only, with reference to the attached figures.

FIG. 1 is a diagrammatic view showing an applied environment of a video surveillance device.

FIG. 2 is a block diagram of an embodiment of the video surveillance device of FIG. 1.

FIG. 3 is a diagrammatic view of an original image generated by the video surveillance device of FIG. 2.

FIG. 4 is a flowchart of an embodiment of a video surveillance method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

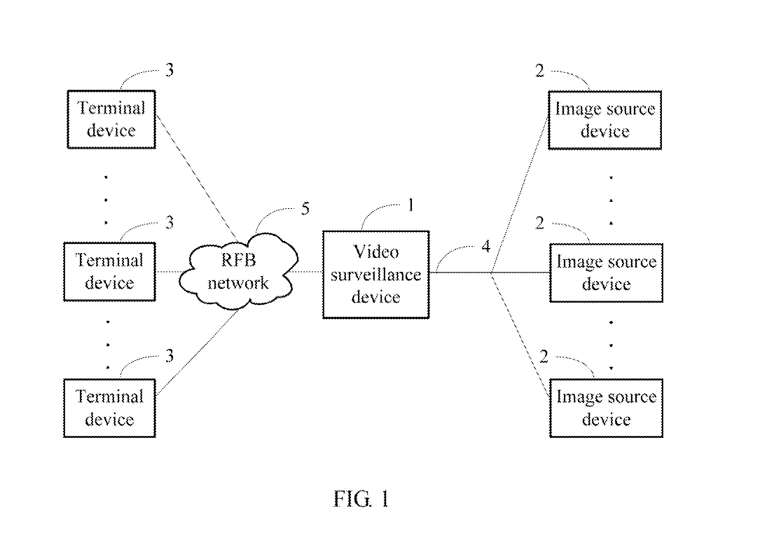

FIG. 1 illustrates a video surveillance device 1 coupled to a number of image source devices 2 through a real-time streaming protocol (RTSP) cable 4 for example, and is further coupled to a number of terminal devices 3 through a remote frame buffer (RFB) network 5 which transfers video or image data according to an RFB protocol. The image source device 2 can be a network video recorder (NVR) or an internet protocol (IP) camera that can capture images in real-time. The terminal device 3, such as a monitor device, a personal computer, a mobile device, or a personal digital assistant (PDA) device, can display the images captured by and received from each image source device 2.

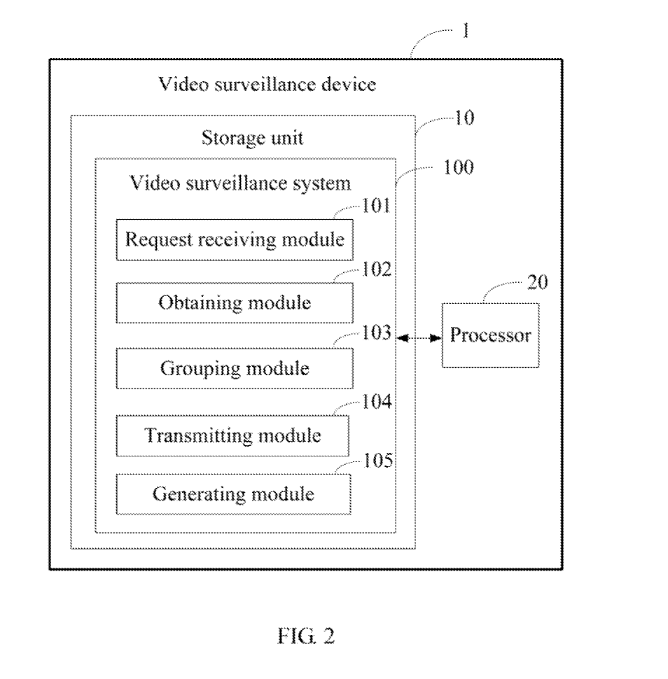

Referring to FIG. 2, the video surveillance device 1 can include a storage unit 10 and a processor 20. The storage unit 10 can store a video surveillance system 100. The system 100 can include a variety of modules as a collection of software instructions executable by the processor 20 to provide the functions of the system 100.

In the example illustrated in FIG. 2, the system 100 can include a request receiving module 101, an obtaining module 102, a grouping module 103, and a transmitting module 104.

The request receiving module 101 receives a request from at least one terminal device 3, and determines whether the request includes information specifying at least two image source devices 2. The specific information of one image source device 2 can be an IP address of that image source device 2.

The obtaining module 102 obtains images captured by each of the at least two specific image source devices 2 in real-time.

The grouping module 103 groups the obtained images together. In at least one embodiment, the grouping module 103 groups the obtained images according to an image resolution classification of each obtained image.

The transmitting module 104 transmits the grouped image to the terminal device 3.

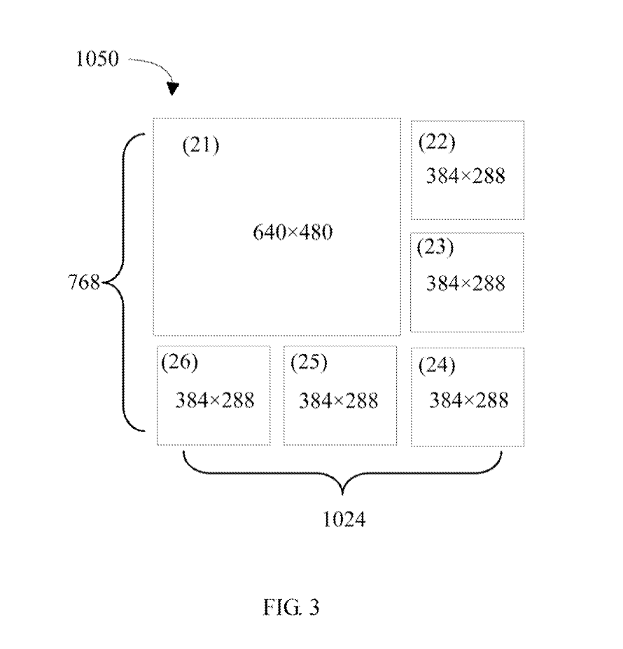

In at least one embodiment, the system 100 further includes a generating module 105. When the request receiving module 101 determines that the request includes information specifying at least two image source devices 2, the generating module 105 generates an original image 1050 (shown in FIG. 3) including at least two blank portions, each blank portion corresponding to one specific image source device 2. The obtaining module 102 obtains the images currently captured by each specific image source device 2 in real-time after the generating module 105 has generated the original image 1050. The grouping module 103 adjusts an overall size and shape of the obtained images from each specific image source device 2 to match an overall size and shape of the corresponding blank portion, and after the adjustment allocates each obtained image into one corresponding blank portion, thereby forming the grouped image. In at least one embodiment, the grouping module 103 further adds an identifier on each obtained image after allocating an obtained image into the blank portion, to inform a user which specific image source device 2 it was that captured the images. The identifier added to one image can indicate the area in which an image source device 2 is located.

In at least one embodiment, the storage unit 10 further stores a relationship between the different image source devices 2 and the image resolution classifications. Each image source device 2 corresponds to one image resolution classification. The generating module 105 determines one image resolution classification corresponding to each specific image source device 2 according to the stored relationship, generates blank portions of sizes which are determined according to the image resolution classification of the corresponding specific image source device 2, and groups the generated blank portions together into the original image 1050. Referring to FIG. 3, the request includes six specific image source devices, 21, 22, 23, 24, 25, and 26, for example. After determining that the image resolution classification from image source device 21 is 640×480, and the image resolution classification from each of the image source devices 22-26 is 384×288, the generating module 105 generates an original image 1050 having six blank portions. The image resolution classification of the original image 1050 is 1024×768. In at least one embodiment, the location of each blank portion on the original image 1050 is arranged randomly.

In at least one embodiment, the terminal device 3 further periodically sends a new request to the video surveillance device 1, to request the video surveillance device 1 to periodically obtain the real-time captured images from each specific image source device 2. For example, the terminal device 3 can send a new request to the video surveillance device 1 every two seconds. The request receiving module 101 receives the new requests from the terminal device 3. The obtaining module 102 obtains the images captured by each specific image source devices 2 in real-time every time that the request receiving module 101 receives a new request from the terminal device 3. Then, the grouping module 103 repeats the grouping of the obtained images, and the transmitting module 104 repeats the transmitting of the grouped image to the terminal device 3. As such, the terminal device 3 successively displays a number of grouped images from the specific image source devices 2.

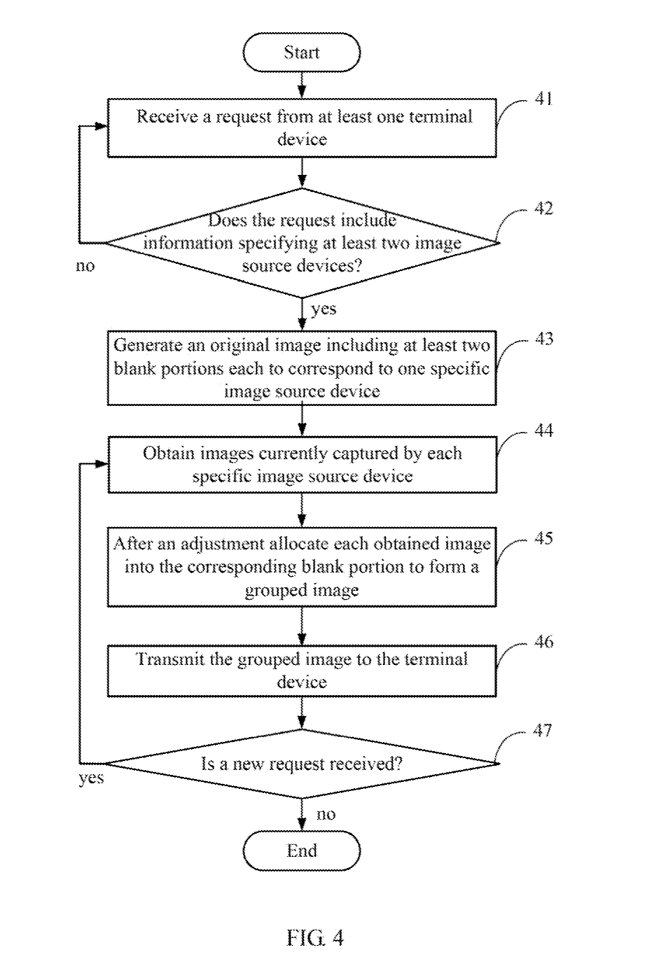

FIG. 4 is a flowchart of an embodiment of a video surveillance method.

In block 41, a request receiving module receives a request from at least one terminal device.

In block 42, the request receiving module determines whether the request includes information specifying at least two image source devices; if yes, the process proceeds to block 43; otherwise block 41 is repeated.

In block 43, a generating module generates an original image including at least two blank portions each to correspond to one specific image source device.

In block 44, an obtaining module obtains images currently captured by each of the at least two specific image source devices in real-time.

In block 45, a grouping module adjusts an overall size and shape of the obtained images from each specific image source device to match an overall size and shape of the corresponding blank portion, and after the adjustment allocates the obtained images into the corresponding blank portion, thereby forming a grouped image.

In block 46, a transmitting module transmits the grouped image to the terminal device.

In block 47, the request receiving module determines whether a new request from the terminal device is received; if yes, block 44 is repeated; otherwise the process ends.

The embodiments shown and described above are only examples. Many details are often found in the art such as the other features of a video surveillance device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A video surveillance device capable of communicating with a plurality of image source devices and a plurality of terminal devices, the video surveillance device comprising:
a storage unit for storing a plurality of modules; and
a processor to execute the plurality of modules,
wherein the plurality of modules comprises:
a request receiving module configured to receive a request from at least one terminal device, and determine whether the request comprises information specifying at least two image source devices;
an obtaining module configured to obtain images captured by each of the at least two specific image source devices in real-time;
a grouping module configured to group the obtained images together; and
a transmitting module configured to transmit the grouped image to the at least one terminal device.

2. The video surveillance device of claim 1, wherein the grouping module is configured to group the obtained images together according to an image resolution classification of each obtained image.

3. The video surveillance device of claim 1, wherein the plurality of module further comprises a generating module configured to generate an original image when the obtaining module determines that the request comprises information specifying at least two image source devices, the original image comprises at least two blank portions, each corresponding to one of the at least two specific image source devices; the obtaining module is configured to obtain the images currently captured by each of the at least two specific image source devices after the generating module has generated the original image; and the grouping module is configured to adjust an overall size and shape of the obtained images from each of the at least two specific image source devices to match an overall size and shape of the corresponding blank portion, and after an adjustment allocates each obtained image into one corresponding blank portion, thereby forming the grouped image.

4. The video surveillance device of claim 3, wherein the storage unit further stores a relationship between the different image source devices and image resolution classifications, each image source device corresponds to one image resolution classification, the generating module is configured to determine one image resolution classification corresponding to each of the at least two specific image source device according to the stored relationship, generate blank portions of sizes which are determined according to the image resolution classification of the corresponding image source device, and group the generated blank portions together into the original image.

5. The video surveillance device of claim 4, wherein a location of each blank portion on the original image is arranged randomly.

6. The video surveillance device of claim 3, wherein the request receiving module is further configured to periodically receive a new request from the at least one terminal device, the obtaining module is configured to obtain the images captured by each of the at least two specific image source devices in real-time every time that the request receiving module receives the new request from the at least one terminal device.

7. The video surveillance device of claim 6, wherein the grouping module is further configured to add an identifier on each obtained image after allocating an obtained image into the blank portion.

8. The video surveillance device of claim 7, wherein the identifier added to one image indicates an area in which an image source device is located.

9. A video surveillance method applied in a video surveillance device, the video surveillance device capable of communicating with a plurality of image source devices and a plurality of terminal devices, the method comprising:
receiving a request from at least one terminal device;
determining whether the request comprises information specifying at least two image source devices;
obtaining images captured by each of the at least two specific image source devices in real-time;
grouping the obtained images together; and
transmitting the grouped image to the at least one terminal device.

10. The method of claim 9, wherein the obtained images are grouped together according to an image resolution classification of each obtained image.

11. The method of claim 9, further comprising:
generating an original image comprising at least two blank portions when determining that the request comprises information specifying at least two image source devices, each corresponding to one of the at least two specific image source devices;
obtaining the images currently captured by each of the at least two specific image source devices;
adjusting an overall size and shape of the obtained images from each of the at least two specific image source devices to match an overall size and shape of the corresponding blank portion; and
after an adjustment allocating each obtained image into one corresponding blank portion, thereby forming the grouped image.

12. The method of claim 11, wherein the step of generating an original image comprising at least two blank portions further comprises:
determining one image resolution classification corresponding to each of the at least two specific image source device according to a relationship between the different image source devices and image resolution classifications, each image source device corresponding to one image resolution classification;
generating blank portions of sizes which are determined according to the image resolution classification of the corresponding image source device; and
grouping the generated blank portions together into the original image.

13. The method of claim 12, wherein a location of each blank portion on the original image is arranged randomly.

14. The method of claim 11, further comprising:
periodically receiving a new request from the at least one terminal device;
obtaining the images captured by each of the at least two specific image source devices in real-time every time that receiving the new request from the at least one terminal device;
grouping the obtained images together; and
transmitting the grouped image to the at least one terminal device.

15. The method of claim 11, wherein the step of allocating each obtained image into one corresponding blank portion further comprising:
adding an identifier on each obtained image.

16. The video surveillance device of claim 15, wherein the identifier added to one image indicates an area in which an image source device is located.

17. A video surveillance device, comprising:
a processor accessible by one or more terminal devices and with input from one or more image source devices; and
a storage unit storing a request receiving module, an obtaining module, a grouping module and a transmitting module, the functions of the receiving module, obtaining module, grouping module and transmitting module each being executable by the processor;
wherein, when the device receives a request from at least one of the one or more terminal devices, the request receiving module of the processor determines whether the request specifies input from at least two image source devices;
wherein, if the request receiving module determines that the request specifies input from at least two image source devices, the obtaining module captures images from each of the at least two specified image source devices in real-time;
wherein, the grouping module then groups the captured images together into a grouped image; and
wherein, the transmitting module then transmits the grouped image to at least one of the one or more terminal devices.
